(19) United States
(12) Patent Application Publication
(10) Pub. No.: US 2011/0225894 A1
(43) Pub. Date: Sep. 22, 2011

(54) Method for defined closure of a window pane of a motor vehicle

(75) Inventors: Rolf Ewald, Friedrichshafen (DE); Holger Barzik, Singen (DE)

(73) Assignee: Conti Temic microelectronic GmbH

(21) Appl. No.: 11/918,683

(22) PCT Filed: Feb. 18, 2006
(86) PCT No.: PCT/DE2006/000303

§ 371 Date: Mar. 4, 2011

(30) Foreign Application Priority Data
Apr. 18, 2005 (DE) 10 2005 018 013.2

(51) Int. Cl. B60J 1/17

(52) U.S. Cl. 49/506

(57) ABSTRACT

Disclosed is a method for closing a window pane of a motor vehicle with an externally powered motor vehicle window winder. When the window pane is closed in manual mode, a switch is made from manual mode to automatic mode when a minimum distance between the window pane and the pane seal is not reached, and here, the window pane is moved into the pane seal and the motor run is maintained even when an end position is reached until a defined blocking time is reached.

### BACKGROUND OF THE INVENTION

The invention relates to a method for closing a window pane of a motor vehicle using an externally powered motor vehicle window winder. When closing and opening a window pane of a motor vehicle by means of an externally powered motor vehicle window winder, it is of particular importance that the current position of the window pane is known at all times, or that this position is known to as precise a degree as possible, in order to thus guarantee a safe basis for the functioning of an anti-jamming protection device. For this purpose, the position of the pane is scaled. With an externally powered motor vehicle window winder, the drive is automatically switched off and reversed if necessary when the window pane meets an obstacle which has been jammed between the upper edge of the pane and the frame of the window pane. Here, the problem arises, however, that movement of the window pane into the upper pane seal can be interpreted as being a jam due to a resistance applied by the pane seal against the adjustment movement of the window pane. In this case, the externally powered window winder would automatically switch off, and the window pane would not move completely into the upper pane seal.

A method for scaling the pane position of an externally powered window winder is known from DE 199 21 092 C1, in which the window pane is moved by means of the window winder drive into a closed position which is provided with a sealing area, and this closed position is used for scaling the pane position. In order to check whether the window pane has reached is closed position, the change in a value which correlates with the dynamic of the window pane is evaluated when the window pane moves into the sealing area assigned to the closed position. A scaling procedure is conducted, i.e. a reference position is provided on the upper mechanical stop. In order to ensure that the upper mechanical stop has actually been reached, the characteristic behaviour of the seal is also taken into account. When the characteristic behaviour occurs when the pane enters the sealing area, a typical pane speed reduction can here be determined by the inhibiting effect of the sealing lip, and if a mechanical block/obstacle is then determined, according to this invention, a scaling procedure is then conducted.

A method for determining the position of an element which is driven by the drive shaft of a direct current motor within a pre-specified movement path between two block positions is known from DE 100 28 038 A1. The position is determined by evaluating the current ripple contained in the anchor current signal. Here, a scaling procedure is conducted by the system when the driven element is moved into a defined block position. When the driven element is moved into a block position, the direct current motor is switched currentless before the block position defined by the system is reached, and after a pre-specified time period, it is again activated to finally move the driven element into the block position. After the driven element has been brought into its mechanically defined block position, the system scales this block position.

This scaling on the upper mechanical stop of the driven element is designed to counter the possibility which arises when a closure system moves against a mechanical stop with different kinetic energy, i.e. with a different speed. Due to this different kinetic energy, the reference point may be displaced, in particular with a soft, somewhat elastic mechanical stop. This leads to imprecision with regard to the reference position. An attempt is made to avoid this by stopping the engine run shortly before the mechanical block position is reached, whereby the position is determined by means of current ripple counting, before switching it back on again. In this way, the aim is to reduce the variances in kinetic energy to the extent that a reliable reference position can be anticipated.

A method for the position-dependent control of an adjustment element which is electrically driven by an adjustment device which can be moved in a drive movement in a motor vehicle is known from DE 102 58 476 A1. Here, the adjustment device evaluates a plurality of different operating modes and characteristics of a drive signal from the adjustment device, in particular, the ripples of a drive current, in order to determine the position of the element. It is provided that a nominal value and/or a value which characterises the adjustment device which influences the drive movement of the adjustment device is evaluated in order to determine an error value of the determined position of the adjustment element, and that the drive modes of the adjustment device are controlled in relation to the determined error value. The position is obtained by means of current ripple counting. This type of position determination is very inaccurate under certain conditions. During engine start-up, under heavy loads, with fluctuations in the on-board network voltage, temperature fluctuations, ageing of the system etc., position losses may occur, and thus, problems with the anti-jamming protection switch off position may arise specifically with anti-jamming protection systems. With the object of this invention, therefore, certain conditions such as fluctuations in the on-board network voltage are recorded, and the function of the movable adjustment element is controlled accordingly.

A method for restricting the surplus force of an electrically controlled, externally powered aggregate is known from DE 196 28 203 C2 which can advantageously be used in particular in connection with window winders which are equipped with an anti-jamming detection device. The method is characterised by the fact that the closing area is assigned at least one correlation value as a switch-off criterion, which increases the adjustment force available in the closing area by an amount specified by the electronic unit in comparison with a value measure in the prior intake area of the closing area. The amount of the increase is calculated as a relative value on the basis of the previously measured value of the correlation value. Here, the closing forces which are required to cleanly close the pane so that it is sealed tight in the upper seal are restricted. Normally, the pane moves with maximum motor power into the upper seal through to the mechanical block position. However, this means at the same time that the forces which act on the entire mechanical system are very high. In order to reduce these forces, the characteristic behaviour of the seal is evaluated.

The disadvantage with all of these known methods is however the fact that a scaling procedure can only be conducted when the window pane is brought into a final position by means of the externally powered motor vehicle window winder which is detected. This end position is usually automatically reached when the user closes the window pane in automatic mode. The externally powered motor vehicle window winders have a so-called “manual mode”, however, in which the user is able to move the motor vehicle window pane into any required position. Since when a switch is made between different positions of this type the control unit of the externally powered motor vehicle window winder is no longer able to determine the precise position of the window pane, however, an obligatory scaling procedure must be conducted. It has been shown, in particular in the use of systems of this type, that different users neither completely open nor completely close the window pane with the externally powered motor vehicle window winder, but that they frequently unconsciously or consciously stop the window pane before one of the end positions has been reached, so that the control unit of the externally powered motor vehicle window winder loses the actual position of the window pane after a certain period of time.

Since, however, as has been described, it is necessary in order to correctly record the position with externally powered motor vehicle window winders with an anti-jamming function, to check the position of the window pane after a certain number of window runs, and if necessary, to correct it (known as post-scaling), and since, as described above, it frequently occurs in practise that the user does not activate the manual run up switch for a sufficient length of time (motor activation for as long as the switch is pressed) in order to reach the post-scaling stage, the consequence is imprecision with regard to the position counting, which can lead to erroneous reversing on the seal or to the jamming of 4 mm jamming objects which in principle should be detected.

The object of the invention is to prevent this problem from arising, and to guarantee that a scaling procedure is conducted when the window is wound up manually.

### SUMMARY OF THE INVENTION

This object is attained by a method for closing a window pane (2) of a motor vehicle with an externally powered motor vehicle window winder which is equipped with an electronic anti-jamming protection device, whereby the externally powered motor vehicle window winder comprises an automatic mode and a manual mode for opening and closing the window pane (2), whereby in the end position of the window pane (2), a scaling procedure is conducted in order to determine the position. When the window pane (2) is closed in manual mode when a minimum distance between the window pane (2) and the pane seal (1) is not reached a switch is made from manual mode to automatic mode, and the window pane (2) is moved into the pane seal (1) and the motor run is maintained even when the end position (4) is reached until a defined blocking time is reached. Advantageous embodiments of the invention will be apparent from the further description and the figures.

According to the invention, with an externally powered motor vehicle window winder, the position of the window is monitored when it is closed by means of a Hall sensor. When the window pane or the sliding roof which is moved via the raising system reaches the proximity of a block position, e.g. with window winders, the area of the upper window seal, this is detected by the control unit via the signals which are recorded and delivered by the Hall sensor. If the window pane moves into the upper seal of the frame of the window pane, and if the Hall sensor records no further position changes, i.e. no further Hall impulses for a specified time period of e.g. 300 ms, the window pane position is checked and if necessary, corrected, i.e. post-scaled. This so-called blocking time can be freely selected and typically lies between 100 ms and 500 ms.

The raising system consists of an electric motor and a control unit. The electric motor is usually connected via two switches with an operating voltage and a reference potential (earth) via a resistance, whereby one switch is always switched in the direction of the operating voltage, and the other switch is always switched in the direction of the reference potential (earth). In order to switch off the electric motor, both switches are set to reference potential (earth), so that the motor voltage is zero over the electric motor. The electric motor comprises a magnet wheel and a corresponding Hall sensor, which delivers a digital signal to the control unit.

If the user moves the window pane in manual run-up mode in the direction of the upper window seal by means of the externally powered motor vehicle window winder, the current position of the window pane is continuously monitored by the Hall sensor. The position of the window pane is determined by the control unit on the basis of the values determined by the Hall sensor, and when the sealing position is reached, i.e. the position of the window pane, in which the anti-jamming protection can be deactivated since no further jamming can occur, a switch is made from the manual run-up of the window pane via the externally powered motor vehicle window winder to automatic run-up, in order to move the window pane into the seal with the maximum motor power. In automatic run-up mode, the motor run is maintained until the blocking time has been reached, and thus a position check and position correction is conducted.

If with the method according to the invention the anti-jamming switch-off position is exceeded during manual run-up, which is the case for example when the sealing area is reached, or when the distance between the window pane and the seal is less than 4 mm, the control unit switches to automatic run-up mode in order to ensure that a position check and position correction are conducted. Generally, a position check and position correction are conducted after a typical motor blocking time of between 100 ms and 500 ms on the position of the upper mechanical block position.

### BRIEF DESCRIPTION OF THE DRAWINGS

The invention will now be explained using a specific exemplary embodiment and with reference to the drawings, in which:

FIG. 1 shows a schematic circuit arrangement for the control of a window winder in a motor vehicle, and

FIG. 2 shows a schematic method of functioning of the invention on the basis of a car window pane in a car door.

### DETAILED DESCRIPTION OF THE DRAWINGS

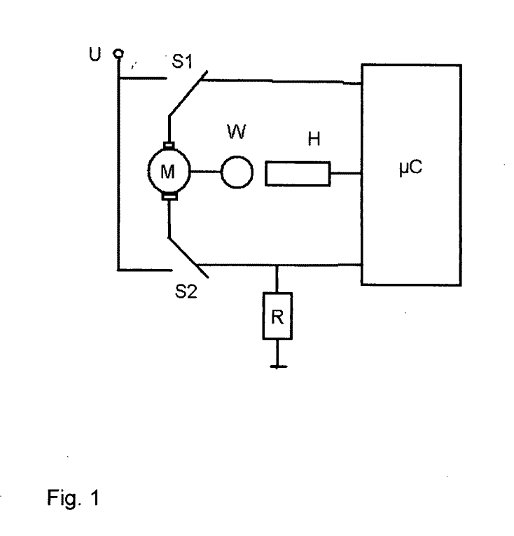

FIG. 1 shows a schematic circuit arrangement for controlling a window winder in a motor vehicle, whereby only those elements required in order to understand the invention are shown.

An externally powered motor vehicle window winder system consists of an electric motor M and a corresponding motor control unit μC. The electric motor M is connected via two switches S1, S2 with the operating voltage U on the one hand, and with the earth via a resistance R on the other hand. In order to switch off the electric motor, both switches S1 and S2 are set to earth. The electric motor M comprises a magnet wheel W and a corresponding Hall sensor HS. The output of the Hall sensor HS is directly connected to the motor control unit μP. The motor control μP determines the position of the window pane on the basis of the signals from the Hall sensor HS.

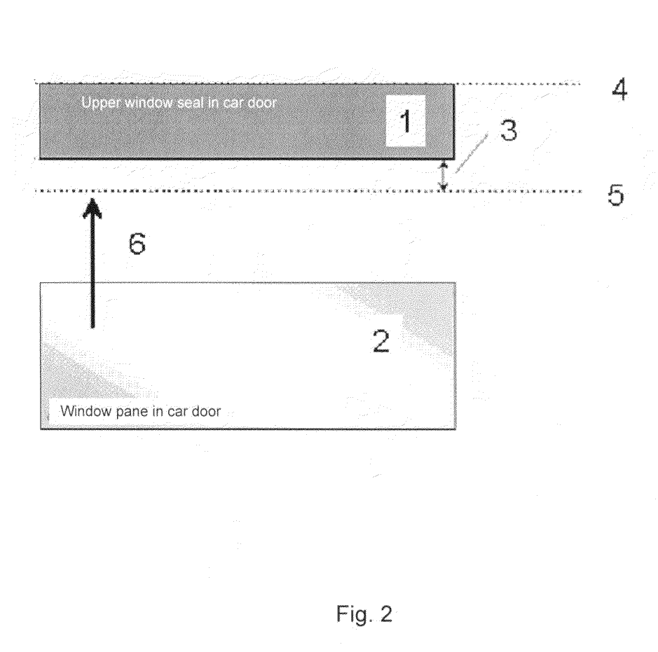

FIG. 2 shows the schematic method of functioning of the invention on the basis of a car window pane in a car door.

The user has two ways of operating the window winder. There is the automatic mode in which the window pane 2 is fully opened or closed and the motor control unit μP automatically fully closes or opens the window pane 2 taking into account the anti-jamming protection device. When closing in automatic mode, the window pane 2 is moved with maximum motor power into the upper block position 4 for a pre-specified time period when the anti-jamming protection switch-off position 3 is exceeded, and when the upper block position 4 is reached. Here, the system of the externally powered motor vehicle window winder is then scaled.

If the user moves the window pane 2 in manual mode with the externally powered motor vehicle window winder in the direction of the upper window seal 1, the current position of the window pane 2 is continuously monitored by the motor control unit μP on the basis of the values delivered by the Hall sensor HS. The position of the window pane 2 is determined by the motor control unit μP on the basis of the values determined by the Hall sensor HS, and when the sealing position is reached, i.e. the position of the window pane 2, in which the anti-jamming protection can be deactivated since no further jamming can occur, a switch is made from the manual run-up of the window pane 2 via the externally powered motor vehicle window winder to automatic run-up, in order to move the window pane 2 into the seal 1 with the maximum motor power. In automatic run-up mode, the motor run is maintained until the blocking time has been reached, and thus a position check and position correction is conducted.

If the anti-jamming switch-off position 5 is exceeded during the manual run-up initiated by the user, which is the case for example when the sealing area is reached, or when the distance between the window pane and the seal is less than 4 mm (reference numeral 3 in FIG. 2), the motor control unit μP switches to automatic run-up mode in order to ensure that a position check and position correction are conducted.

In an advantageous embodiment of the invention, a counter is provided which counts the number of activations of the externally powered motor vehicle window winder. Depending on the value of this counter, the motor control unit μP conducts an automatic run-up in order to ensure that a position check and a position correction are conducted. This typically occurs when the number of activations exceeds forty. After each automatic run-up and position check and position correction, the counter is reset to zero.

1-8. (canceled)

9. A method for closing a window pane (2) of a motor vehicle with an externally powered motor. vehicle window winder which is equipped with an electronic anti-jamming protection device, wherein the externally powered motor vehicle window winder comprises an automatic mode and a manual mode for opening and closing the window pane (2), the method comprising:
performing a scaling procedure in an end position of a window pane (2) in order to determine a position;
switching from manual mode to automatic mode when the window pane (2) is closed in manual mode when a minimum distance between the window pane (2) and the pane seal (1) is not reached; and
maintaining the motor run even when the end position (4) is reached until a defined blocking time is reached.

10. The method of claim 9, wherein a defined blocking time of at least 200 ms is reached.

11. The method of claim 10, wherein with after the defined blocking time has expired, a scaling procedure is conducted.

12. The method of claim 11, wherein the scaling procedure is conducted in the form of a post-scaling procedure.

13. The method of claim 9, wherein the position of the window pane (2) is determined by a motor control unit (μP) on the basis of the values from a Hall sensor (HS).

14. The method of claim 13, wherein the motor control unit (μP) is informed of the number of activations of the externally powered motor vehicle window winder by means of a counter, and an automatic run-up is initiated by the motor control unit (μP) when a pre-defined value of the counter is reached.

15. The method of claim 9, wherein an automatic run-up is conducted when the externally powered motor vehicle win-dow winder is activated over forty times.

16. The method of claim 9, wherein after each automatic run-up and after each position check and each position cor-reaction, the counter status is reset to zero.
